(19) United States
(12) Patent Application Publication
(10) Pub. No.: US 2006/0087445 A1
(43) Pub. Date: Apr. 27, 2006

(54) Programmable remote controller adapted to be programmed by playback of audiovisual content

(76) Inventor: Stuart Antony Green, Sheffield (GB)

Correspondence Address: DAVID E. HUANG, ESQ.;BAINWOOD HUANG & ASSOCIATES LLC, 2 CONNECTOR ROAD, SUITE 2A, WESTBOROUGH, MA, 01581, US

(21) Appl. No.: 11/255,469

(22) Filed: Oct. 21, 2005

Related U.S. Application Data
(60) Provisional application No. 60/622,543, filed on Oct. 27, 2004.

(30) Foreign Application Priority Data
Oct. 25, 2004 (GB) 0423645.1

(51) Int. Cl. G05B 19/02

(52) U.S. Cl. 340/825.22; 340/825.69; 348/734; 398/106; 367/197

(57) ABSTRACT

A remote controller comprises a receiver (365) for receiving programming information for programming the remote controller and a transmitter (355) for transmitting remote control signals for controlling remote equipment. Conveniently the receiver (365) is sensitive to the playback of audio or video content to receive therefrom information for programming the remote controller. In this way, a programmable remote controller may be programmed using playback of appropriately encoded audio or video content, for example, using a combination of a DVD player to play the content and a television to reproduce the audio and/or video content.

### CROSS REFERENCE TO RELATED APPLICATIONS

This Patent Application is a U.S. Utility Patent Application of U.S. Provisional Patent Application No. 60/622,543, filed Oct. 27, 2004, entitled “REMOTE CONTROLLERS” and UK Patent Application No. 0423645.1, filed Oct. 25, 2004 entitled “REMOTE CONTROLLERS”, the entire contents and teachings of which are hereby incorporated by this reference.

### FIELD OF THE INVENTION

The present invention relates to remote control apparatus and devices of the kind typically employed to control the operation of home electronic and/or audio/visual systems and equipment. Particularly, but not exclusively, aspects and embodiments of the present invention relate to remote controllers that can be programmed and systems incorporating, and methods for using and programming, such remote controllers.

### BACKGROUND OF THE INVENTION

Remote controllers are widely used to control consumer equipment, such as music systems, CD players, video players, televisions, satellite receivers and DVD players. Indeed, nowadays, most equipment of this kind is provided at the time of purchase with a dedicated remote controller, which is programmed with all the codes necessary to control commonly used functions of the equipment. Other kinds of equipment and systems, for example alarm systems, lighting systems and the like can also be controlled using similar remote controllers. Herein, any system, device, apparatus or the like that is arranged to be controlled by a remote controller will simply be referred to as “equipment”.

Nowadays, most common remote controllers employ an infrared signal format to control the equipment; therefore, the remote controller includes an infrared transmitter—typically an LED—and the equipment includes an infrared receiver—typically a photo-detector. A signal format typically comprises control codes, each represented by a different sequence of pulses, which are modulated onto an optical carrier, for example operating at 40 kHz. In some prior art remote controllers, optical carriers may be as high as, or even exceed, 400 kHz. The pulses themselves may be transmitted at a rate of around 9600 baud. Unless context, or respective description, dictates otherwise, the combination of signal format and control codes, which are used to generate the control signals that enable a remote controller to control respective equipment, will be referred to herein as a ‘command protocol’.

Different kinds of equipment, and different manufacturers of the equipment, use different command protocols: that is different combinations of signal formats and control codes. This is necessary in order to prevent one remote controller that is supplied with one item of equipment from inadvertently controlling another item of equipment.

Therefore, historically, as households have acquired more makes and categories of equipment, they have also acquired plural dedicated remote controllers, and it is perceived as problematic to keep track of and use increasing numbers thereof.

The advent of programmable remote controllers, which are commonly referred to as Universal Remote Controllers (URC), has to some extent addressed these problems. A URC can be programmed with plural different command protocols in order to control plural kinds of equipment. A typical URC, thus, needs to be able to generate a wide range of control signals as well as wide range of carrier frequencies.

A typical URC has a traditional operator interface (such as a keypad, touch pad, touch screen or the like), and additional means, such as for example ‘mode keys’, for selecting which item of equipment to control. For example, a URC may have one ‘increase volume’ key, and pressing that key may selectively control a television, a music system or a home theatre system, depending on which mode key was selected beforehand.

While a URC removes the requirement to keep plural dedicated remote controllers to hand, it does have other perceived disadvantages.

For example, before it can be used, a URC has to be programmed to operate with each item of equipment in a household. The programming operation can be achieved, depending on the type of URC, in one or more of a number of known ways.

One known way of programming a URC is by using a ‘preset code entry’ method, as described in U.S. Pat. No. 5,872,562 (McConnell et al.). This method typically requires the URC to store all of the command protocols for the different categories and manufacturers of equipment. The URC is typically accompanied by a booklet containing a list of the equipment that can be controlled, with each entry in the list having a respective, unique numeric identity code. In order to program the URC to control particular equipment, the user first places the URC into a ‘program’ mode and then enters the identity code that corresponds to the equipment to be controlled. The identity code activates all appropriate buttons on the URC with an appropriate command protocol for that equipment. This operation is enacted for each item of equipment possessed (subject typically to a maximum number, for example six, at any one time) so that the single URC is selectively able to control plural items of equipment.

A perceived advantage of the aforementioned code entry method is simplicity of programming, with each item of equipment being programmed by a single identity code entry. However, an obvious disadvantage is that new makes and models of equipment, each potentially accompanied by a new command protocol, are being introduced all the time. Accordingly, it is impossible to ‘future proof’ a URC that relies on the code entry method alone. In addition, the storage requirements for the command protocols increase as more and more kinds of equipment become available, which can unduly increase the cost of the URC.

An adaptation of a preset code entry method is described in international patent application WO/03/056531 (Lee et al.). In this the inventors propose that the act of manually setting up a URC, by selecting the command protocols, is onerous. They propose a means to automate the set-up process involving modifying remote equipment, say a television, to include an infrared transmitter, which emits a unique identification signal of the equipment, and adapting the URC to incorporate an infrared receiver. The URC is adapted to receive the identification signal, when the unit is pointed at the equipment, and automatically select the appropriate command protocol from an internal library of stored protocols. A perceived disadvantage of this kind of arrangement is the need to upgrade equipment to include the infrared transmitter and associated controller circuitry.

Another known way of programming a URC is by using a ‘learning’ method, as described in U.S. Pat. No. 4,623,887 (Welles). Unlike a dedicated remote controller, which typically employs only an infrared transmitter for transmitting control signals to equipment, a URC that can employ a learning method typically also has an infrared receiver, which is able to receive control signals from a dedicated remote controller. When set into a program mode, this kind of URC is typically aligned with and arranged to receive control signals transmitted by a dedicated remote controller in response to user operation. Data representing the signals are stored in a rewritable memory of the URC and assigned to a respective key on the operator interface. Thereafter, when the operator presses the respective key, the control signal is reproduced in order to control the equipment. This learning process is typically enacted for each key that needs to be programmed.

A perceived advantage of a URC that uses the learning method is the flexibility to learn and mimic any signal that is associated with any particular kind of equipment: even ones not yet conceived or produced. In this sense, this kind of URC is future proofed. A perceived disadvantage is that each operation for each piece of equipment needs to be individually learned and assigned to a key of the URC. This means that, for plural pieces of equipment, each supporting plural different operations, dozens of individual URC programming operations may be required. In addition, a URC that employs a learning method requires access to the original, dedicated remote controller. If that controller has been lost or damaged, then it is impossible to program the URC.

An alternative known way of programming a URC is by using a ‘scanning’ method, as described in U.S. Pat. No. 4,703,359 (Goodson et al.). This method relies on the URC being arranged to generate all command protocols that can (potentially) be used to control the operations of all current and future equipment. In a programming mode, the URC is controlled, typically manually, to cycle through the available codes, transmitting respective signals, until the equipment responds to a signal. When the equipment responds to a signal, the user can assign an appropriate key of the URC to the function caused by the signal. Again, this process typically needs to be repeated for each desired function.

The scanning method is more convenient than the learning method, insofar as it enables the URC to be arranged to control any present or future equipment without needing access to the original, dedicated remote controller. However, the process of cycling through, potentially, many thousands of codes, in order to find the correct ones for each piece of equipment, is perceived to be highly onerous.

One further known way of programming a URC involves uploading a desired command protocol from a data source, for example the Internet. Such a URC typically requires the facility to communicate with a personal computer, which can retrieve the information and transfer it, for example via a USB cable or IrDA interface, to the URC.

A perceived advantage of this kind of URC is flexibility of being able to be programmed to operate any equipment (as long as the data is available, for example on-line, from the manufacturer or another source). A perceived disadvantage is the requirement to have access to a personal computer and the Internet and the skill to access the information and program the URC.

### SUMMARY OF THE INVENTION

Aspects and embodiments of the present invention aim to mitigate at least one or more perceived problems of the prior art.

According to a first aspect, the present invention provides a remote controller, comprising a receiver for receiving programming information for programming the remote controller and a transmitter for transmitting remote control signals for controlling remote equipment, wherein the receiver is sensitive to the playback of audio or video content to receive therefrom information for programming the remote controller.

Thus, a new way of programming a remote controller has been conceived, involving playback of audio or video content. This facilitates a whole penumbra of possible new applications, as will now be described.

In preferred embodiments of the present invention, the controller further comprises a processor, an operator interface and memory means. The controller may be arranged to store received information in the memory means. The received information may identify a command protocol for controlling remote equipment. Additionally, or alternatively, the received information may be command protocol information for controlling remote equipment. In either event, the controller may be arranged, in response to respective user interaction with the operator interface, to transmit one or more control codes, which is or are defined by the command protocol, in order to control the remote equipment.

In some embodiments of the present invention, the receiver comprises a microphone. The microphone may be sensitive to sound in the audible frequency range. For example, the microphone may be sensitive to sound generated by one or more loud speakers, through which audio playback is arranged to occur. The loud speakers may, for example, be in a television, a music system or a home theatre system or attached to a personal computer. Alternatively, the receiver may be sensitive to electrical signals that are arranged to stimulate an audio reproduction device, for example a miniature speaker in a headphone. The signals may thus be received via a wired connection, for example a cable or lead terminated at both ends by a phono or miniature DIN plug; one end for plugging into a headphone socket of the playback equipment and the other end for plugging into an appropriately adapted socket of the remote controller. In principle the socket of the playback equipment may instead be a loudspeaker socket or any other socket used for delivering audio-related signals.

In alternative embodiments, the receiver comprises a light detector. The light detector may be sensitive to light in the visible spectrum. For example, the light detector may be sensitive to playback of video content through a visual display unit.

In some embodiments, the controller may be arranged to receive information for programming the remote controller via playback of encoded audio content. For example, the encoded audio content may comprise a pre-defined sequence of audio pulses, frequencies, levels, tones, cadences, or any combination thereof. Other audio encoding schemes may be used instead.

In other embodiments, the controller may be arranged to receive information for programming the remote controller via playback of encoded video content. For example, the encoded video content may comprise a pre-defined sequence of light pulses, intensities, shades, hues, images or any combination thereof. Other video content encoding schemes may be used instead. For example, the encoded video content may comprise one or more barcode images.

According to a second aspect, the present invention provides a method of programming a remote controller, comprising the steps of playing back audio or video content containing programming information for programming a remote controller and arranging a remote controller to receive said information, said remote controller being sensitive to, and programmable by, said information. The programming information may comprise an identifier for identifying a command protocol for controlling remote equipment. This method is analogous to the prior art ‘preset code entry’ method; accept, according to such embodiments, the codes are received via the audio or video content rather than from direct user input.

In addition, or alternatively, the programming information may comprise an entire command protocol for controlling remote equipment. This method is analogous to the prior art ‘learning method’; accept, according to such embodiments, the command protocol is received in one programming step via the audio or video content rather than in many separate programming steps from a dedicated remote controller.

The method may include the step of using the command protocol to program the remote controller, in which case the method may also include the step of using the programmed remote controller to control the remote equipment.

In preferred embodiments, the method comprises the step of playing back the audio or video content using AV apparatus, which reads the content from a data carrier. The data carrier may be removable, or it may be non-removable. If removable, the data carrier may be an optical disc. In this case, the optical disc may (substantially) conform to the DVD-Video format and the AV apparatus would then be a DVD player. Alternatively, the optical disc may be a CD, a CD-ROM, a DVD-Audio disc, or any other format of disc on which audio or video content may be stored. Other kinds of suitable data carriers would include solid-state memory or cards. Alternatively, the data carrier may comprise a hard disk in a personal computer or even a hard disc recorder.

Conveniently, the method may comprise the step of generating one or more user menus for providing a list of equipment that can be controlled by the remote controller. Then, the method may comprise the step, on the basis of a user's menu selection, of replaying audio or video content containing programming information for programming the remote controller to be able to control the selected equipment. Advantageously, the content that defines the menu(s) is co-located on the same data carrier as the audio or video content.

The method may comprise the step of playing audio content in which is encoded information for programming the remote controller. For example, the audio content may comprise a pre-defined sequence of audio pulses, frequencies, levels, tones, cadences, or any combination thereof.

Alternatively, the method may comprise the step of playing video content in which is encoded information for programming the remote controller. For example, the video content may comprise a pre-defined sequence of light pulses, intensities, shades, hues, images or any combination thereof. Alternatively, the video content may be encoded as one or more barcode images.

According to a third aspect, the present invention provides a method of authoring a removable data carrier, such as a DVD, including the step of storing thereon audio or video content containing information for programming the remote controller.

According to a fourth aspect, the present invention provides a removable data carrier, which contains audio and/or video content for programming a programmable remote controller according to the first aspect of the present invention. The data carrier may comprise an optical disc, for example a DVD-Video disc.

In some embodiments, the removable data carrier also contains a film or game title and, then, the audio or video content may comprise information for programming a programmable remote controller to interact with specific functions or aspects of the film or game title. For example, the audio or video content could be additional material on a film or game title.

Further features and advantages of the invention will become apparent from the following description of preferred embodiments of the invention, given by way of example only, which is made with reference to the accompanying drawings.

### BRIEF DESCRIPTION OF THE DRAWINGS

Embodiments of the present invention will now be described by way of example only with reference to the accompanying drawings, of which:

FIG. 1 is a diagram that illustrates a typical home audio/visual system;

FIG. 2 is a diagram of an exemplary remote controller according to an embodiment of the present invention;

FIG. 3 is a functional block diagram of the controller of FIG. 2;

FIG. 4 is a diagram, which illustrates the content of a programming DVD of the kind described in accord with embodiments of the present invention;

FIG. 5 is a flow diagram of a method of programming a remote controller according to embodiments of the present invention;

FIG. 6 are diagrams of exemplary audio encoding schemes, which may be used for encoding audio content;

FIG. 7 is a diagram of an exemplary remote controller according to alternative embodiments of the present invention;

FIG. 8 is a diagram, which represents a displayed menu screen of an exemplary DVD-Video game; and

FIG. 9 is a functional block diagram of the controller of FIG. 7.

### DETAILED DESCRIPTION OF THE INVENTION

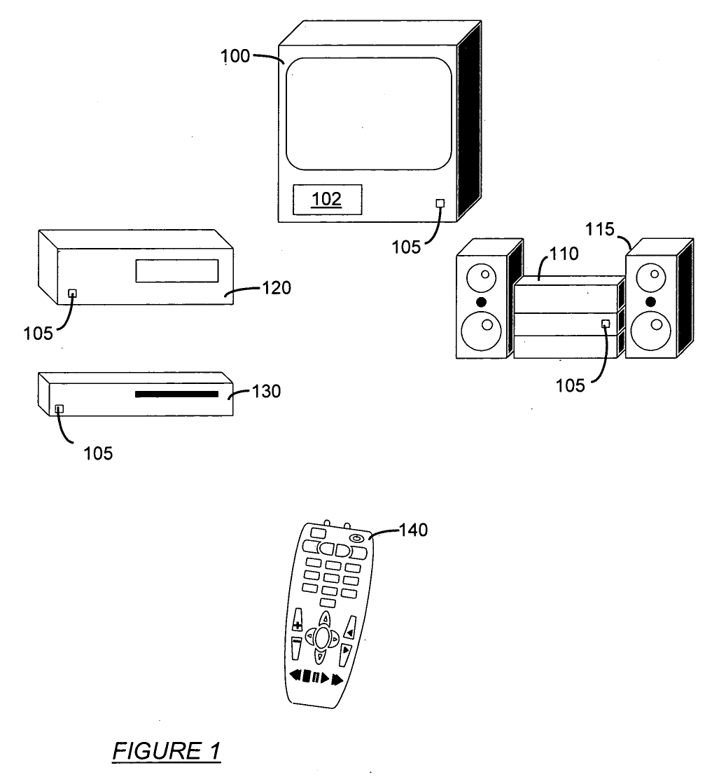

The diagram in FIG. 1 illustrates a typical home audio/visual (AV) system. The system comprises components including a television 100, a stereo music player 110 with speakers 115, a videocassette player/recorder 120 and a DVD player 130. Each component is standard in the art and has an infrared detector 105 for receiving infrared signals from a respective, dedicated remote controller (not shown), which is supplied with each component. Each dedicated remote controller includes an infrared transmitter for transmitting control codes to its respective component. Alternatively, an appropriately programmed URC 140, for example as described hereinafter, can be used to control each component.

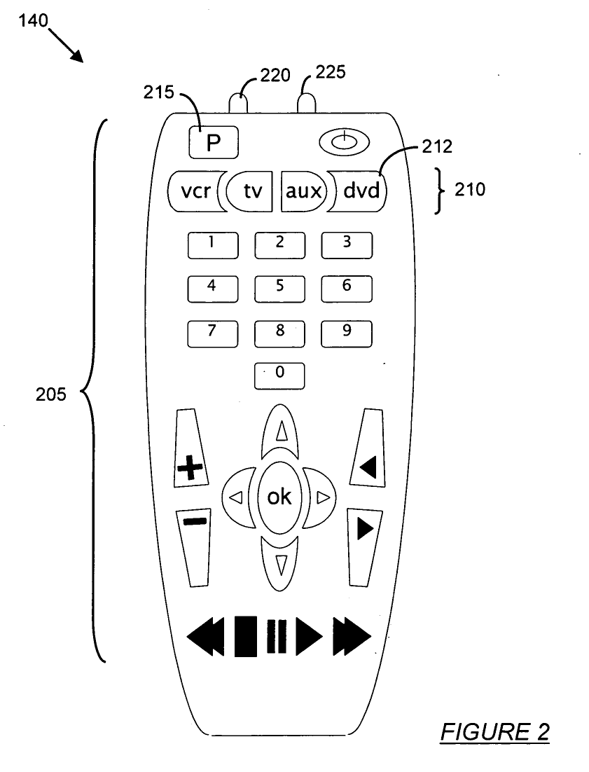

A URC according to an embodiment of the present invention is illustrated in FIG. 2. The URC is similar in many respects to many of the prior art devices, which are suitable for controlling home AV systems. The URC includes an operator interface comprising a keypad 205, which, in this example comprises a plurality of keys. In other examples, the operator interface may comprise a touch screen display, or a combination of keys and touch screen. Some of the keys, when pressed, generate one or more control signals for controlling the standard functions of pre-determined AV equipment. Other keys control aspects of the internal operation of the URC. For example, the keypad includes mode keys 210, for selecting which component (in this case, the television (tv) 100, stereo music player (aux) 110 with speakers 115, videocassette player/recorder (vcr) 120 or DVD player (dvd) 130) to control, and a program key “P” 215, which is used to set the URC into its programming mode. The URC also includes a transmitter 220 and a receiver 225.

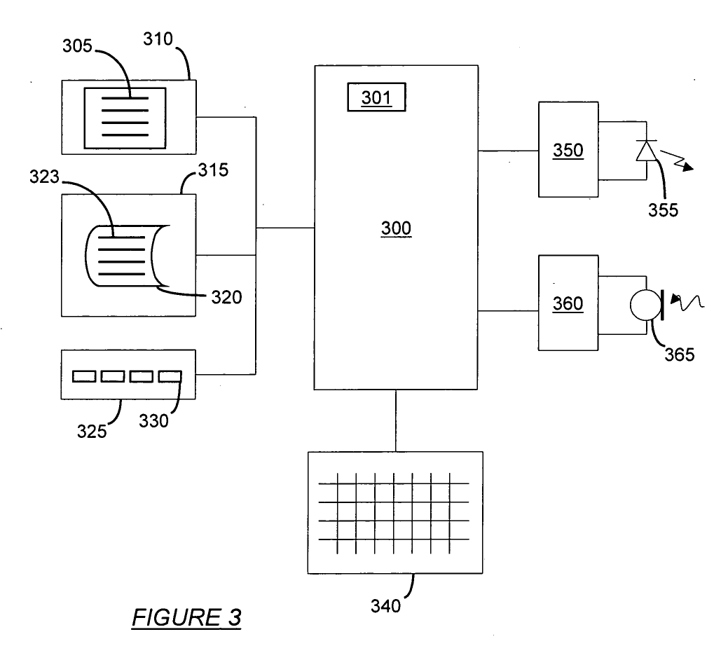

A high-level functional block diagram of the URC of FIG. 2 is illustrated in FIG. 3. Lower level functional components, for example: timing circuits; power supplies; signal and address busses; control logic; decoders; and the like, which are all well-known in the art, are not described herein for the sake of simplicity of description only. Functionally, the URC according to the present embodiment includes a programmed microcontroller 300, which controls all operations of the URC 140. The microcontroller 300 operates according to program instructions 305, which are pre-programmed and stored in a first non-volatile (NV) memory 310, for example comprising a ROM memory. A second NV memory 315, which is rewritable, for example comprising an EEPROM, contains a library 320 of command protocols 323 for a large number of different components that can be controlled by the URC 140. As already mentioned, the command protocols 323 include information describing the signalling format and control codes for each possible component. A third NV memory 325, which is also rewritable, for example again comprising an EEPROM, stores library pointers 330, which are set to point to appropriate command protocols 323 in the library 320.

The URC 140 further comprises a key matrix 340, which is responsive to the keypad 205, a transmitter circuit 350 and a receiver circuit 360.

The transmitter circuit 350 drives an infrared LED 355, for transmitting control signals. The receiver circuit 360, in this embodiment, drives a miniature microphone 365, for example a miniature electret microphone, which is sensitive to audible audio frequencies. Such microphones (and their respective receiver circuits) are commonly used in consumer video cameras, tie-clip microphones and the like and, therefore, are relatively cheap and readily available.

As the skilled person will appreciate, the aforementioned functional description of the URC can be implemented in various different ways. For example, the memory may comprise a single device or plural devices, and at least some of the memory may be integrated ‘on board’ the microcontroller. Indeed, the microcontroller may be replaced with a more flexible microprocessor arrangement.

A method of programming a URC according to the present embodiment uses a ‘programming DVD-Video disc’ (herein referred to as a “pDVD”), which includes interactive content, comprising both video and audio content. The video content comprises a series of hierarchical menus, which are displayed on the television, and the audio content is played through the television's speaker(s) 102 in response to certain menu selections. The menus guide a user through a component selection process and the audio content automatically programs a URC, as will be described.

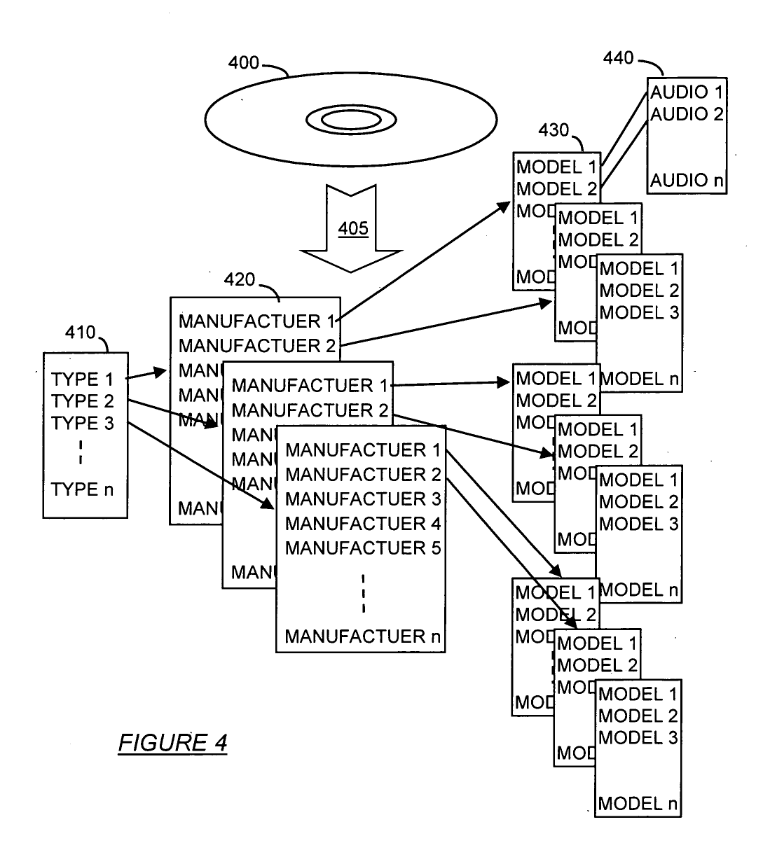

As illustrated in the diagram in FIG. 4, a pDVD 400 contains content 405 defining component type menus 410, component manufacturer menus 420 for each available component type and component model menus 430 for each component manufacturer. In addition, for each supported component model, the pDVD contains audio content 440, which comprises an encoded audio stream (described hereafter) for programming a corresponding URC. In practice, the pDVD content fully complies with the DVD-video format, and the pDVD will play on any format-compliant DVD player. In operation, the DVD player displays the menus, provides respective appropriate user interaction capabilities and produces audio streams purely on the basis of the content defined on the pDVD.

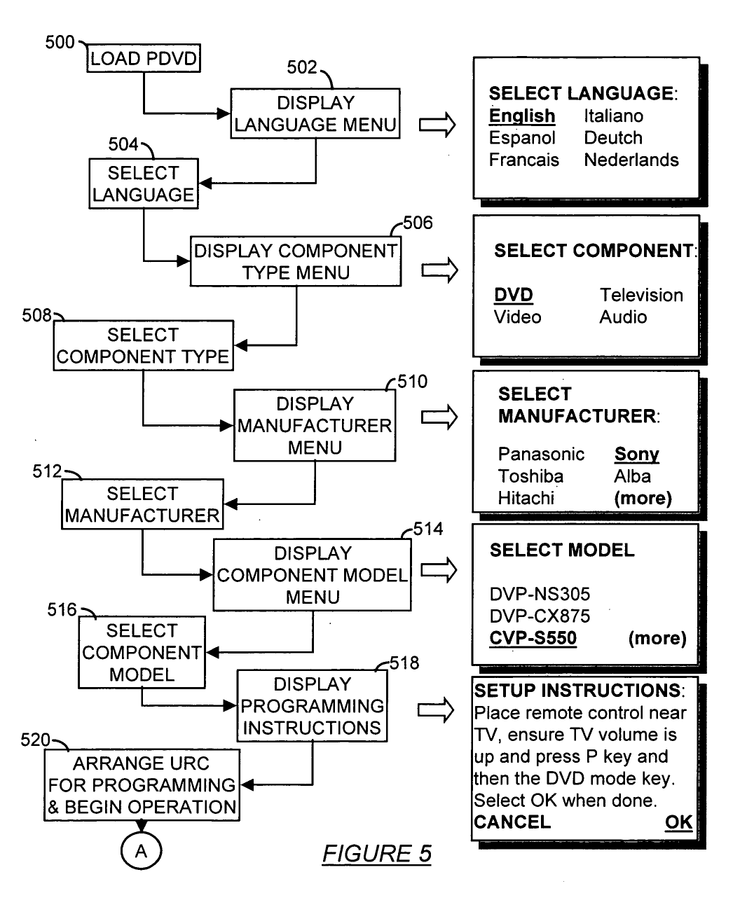

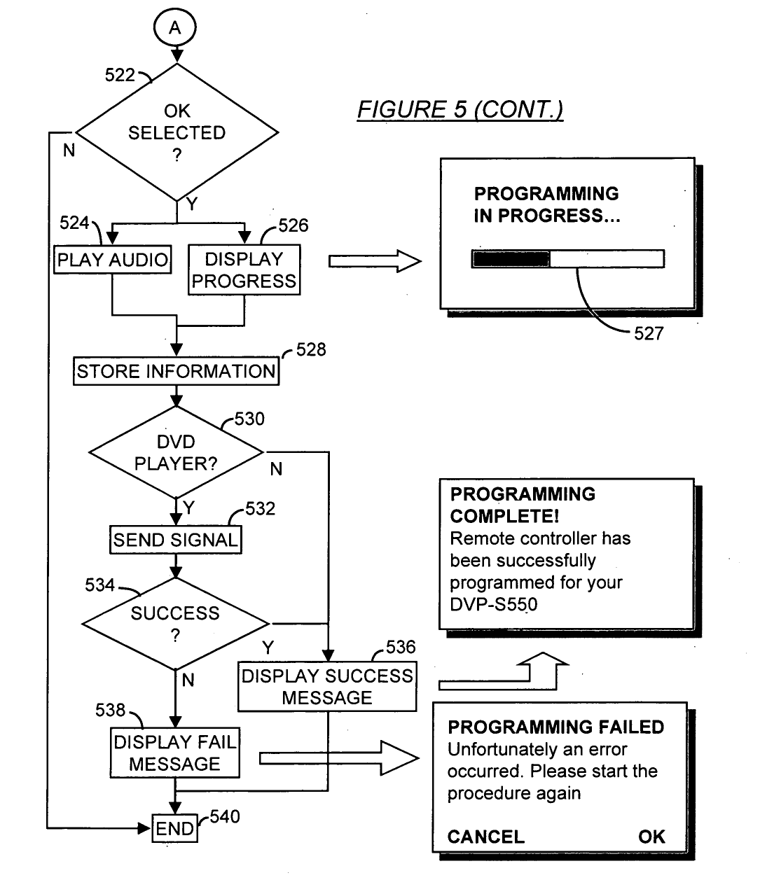

A method of programming the aforementioned URC is described hereafter with reference to the flow diagram in FIG. 5, which is accompanied by representative menu displays.

According to the flow diagram in FIG. 5, in a first step 500, a user loads the pDVD into the DVD player. In step 502, the DVD player displays the first interactive menu, which allows the user to select a language. The user typically controls the DVD player using its dedicated remote controller, unless the URC has already been programmed to control the DVD player. In step 504, the user selects the appropriate language, which causes the DVD player thereafter to use the set of menus that have been authored in the respective language: all menus having been authored in each available language. The DVD player displays the next menu, in step 506, which offers the user a selection of component types that can be programmed in to the URC. In this example, the user has the option of selecting “Television”, “Music System”, “DVD Player” and “Video Player”. Obviously, any other kind of component or other equipment could be included in this list. The user selects the component, in this example “DVD Player”, in step 508. In step 510, the DVD player displays the next menu, which lists the different DVD player manufacturers. The user selects the manufacturer—in this case “Sony”—in step 512. Next, a menu offering all known Sony DVD player model numbers is displayed in step 514. It is likely that not all model numbers can be displayed on a single screen. Therefore, the user can move through plural screens of this menu (and other similar menus), for example by selecting a “more” option. The user selects one model number from the options—in this case “DVP-S550”—in step 516.

Next, in step 518, the DVD player displays a menu screen, which provides the user with instructions on how to arrange the URC in order that it can be programmed to operate the selected component. In this case, the instructions are simple: arrange the URC so that it is near to and pointing towards the television, ensure the television volume is set to a normal listening level (i.e. not too quiet and not too loud), press the ‘program’ or ‘P′ key’ 215, to place the URC in programming mode, and then press the “DVD” mode key 212 on the URC, in order that the subsequent programming step is associated with the DVD mode key. In step 520, the user follows the instructions or selects cancel. If, in step 522, cancel is selected, then the operation ends in step 540. Otherwise, the operation proceeds in parallel steps 524 and 526, in which, respectively, the DVD player plays, through the television speakers, encoded audio content that is associated with the Sony DVP-S550 DVD player and displays a progress screen informing the user that the programming process is taking place. The progress screen may display a progress bar 527, or countdown timer. The user hears the audio content as it is reproduced and the URC 140 receives and stores the audio content in step 528. The nature of the audio content and where it is stored will be considered in more detail below.

The process can continue in one of two different ways, in step 530, according to whether or not the URC is being programmed to control the DVD player, which is playing the pDVD. If the answer is no, a “Programming Complete” message is displayed in step 536 and the process ends in step 540. Once programming is complete, the URC should be programmed to operate a Sony DVP-S550 DVD player. The user can test for successful programming by attempting to use the URC to control the DVD player. If the programming has not worked, the user can re-run the pDVD procedure.

If the URC is being programmed to operate the DVD player, which is playing the pDVD, the process continues in order to provide additional confidence that the process has been successful. Specifically, after the DVD player has played the encoded audio content and the URC should have been programmed, in step 532, the URC is arranged to send confirmation signals to the DVD player, in the form of an instruction to move to the “Programming Complete” menu screen. In step 534, if the DVD player does not receive the confirmation signals within a reasonable time period, for example five seconds, the DVD player automatically displays a “Programming Failed” menu screen in step 538, with an instruction to repeat the procedure, and the procedure ends in step 540. If the instruction is received, it is clear programming has completed successfully and, in step 536, the “Programming Complete” screen is displayed, and then the process ends in step 540.

The aforementioned process can be used in accord with different embodiments of the present invention, which vary in terms of what programming information is contained in the replayed audio content.

In a first embodiment, the audio content contains a numeric value, which is stored in the third NV memory 325 in a location 330 associated with DVD mode key 212 presses.

The stored numeric value is in fact a library location pointer, which points to a location in a pre-stored URC command protocol library 320, which stores the command protocol 323, among many others, for a Sony DVP-S550 DVD player.

After programming is complete, the user uses the URC to control the DVD player in the normal manner, by pressing the DVD mode key 212 and then operating appropriate keys to control the player. When the user presses the DVD mode key 212, the URC reads the numeric value 330 from the third NV memory 325 and places it into a register 301 in the microcontroller 300. The microcontroller 300 uses the numeric value to locate the appropriate starting point in the library 320 for the Sony DVP-S550 DVD command protocol. When the user presses a component control key on the keypad 205, in order to control the DVD player, an offset value associated with the key is generated and used to access a library location that is offset from the starting point, in order to read the respective control code for that key. The control code is returned to the microcontroller and used to generate a respective control signal, which is transmitted, via the transmitter circuit and infrared LED, to the DVD player.

The audio content, which programs the URC, can be encoded in any appropriate manner. The code may be a simple binary code with a sufficient number of bits to identify all makes and models of AV equipment. For example, the code may be 16-bits in length, providing a maximum of 65536 alternatives. Preferably, however, the code will provide a certain amount of redundancy, in order that, for example, single bit errors are identified as errors rather than valid codes for different equipment. There are many known redundancy codes suitable for this purpose. More complex error detection and correction codes may, of course, be used.

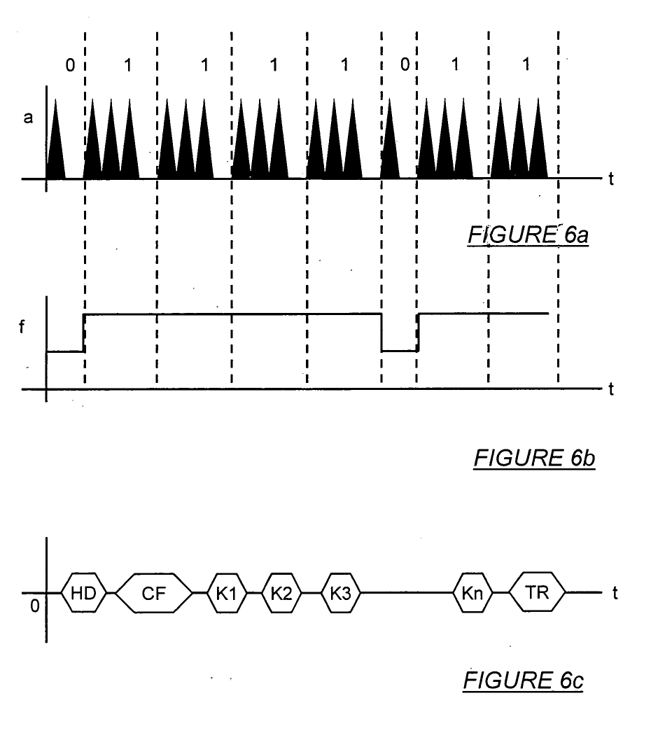

By way of example only, the code may be written as an audio stream, in which binary is are represented as a rapid succession of three short ‘beeps’ (monotones or audio pulses) and a single beep represents a binary 0. Each binary 1 or 0 may be separated by a short period of no sound. The amplitude against time graph illustrated in FIG. 6a represents the decimal number 123 (11011110₂, with the least significant bit leading) using this coding scheme and an eight-bit code. In some embodiments, the audio stream may include a header portion (not shown), for example a sequence of beeps or a relatively long monotone, to prime the URC to expect a code transmission, and an ending tone, or series of beeps, (also not shown) to indicate the end of the transmission. An alternative encoding scheme may use different frequencies of sound to indicate binary 1s and binary 0s. For example, the frequency against time graph in FIG. 6b represents the decimal number 123 encoded using a high frequency tone to represent a binary 1 and a lower frequency tone to represent a binary 0.

It will be appreciated that the first encoding scheme is convenient, since 1s and 0s are independently distinguishable. In other words, there is no requirement to use timing recovery or clock synchronisation in order to decode the information. In contrast, the second encoding scheme does not distinguish between two bits having the same value. As such, the second encoding scheme requires some form of timing recovery in order to distinguish between consecutive bits having the same value. Conveniently, DVD playback timing is extremely stable and predictable, meaning it is a relatively easy task to decode the signal without requiring complex clock recovery circuitry. Instead, a simple logic and timer circuit can be used to, in effect, chop a monotone into its individual bits.

It will be appreciated that many different sound-encoding schemes may be applied to embodiments of the present invention. For example, the 1s and 0s may be distinguished by being encoded using different volumes, different cadences, or in any other appropriate combination or manner.

Alternatively, the encoding need not be in binary. For example, the code may be ternary or quaternary. However, the simplicity of the present requirements means that binary is probably sufficient for the chosen encoding scheme.

The foregoing embodiment, in many respects, is analogous to the ‘code entry’ method, insofar as the URC is pre-programmed with all known command protocols. As has already been described, a disadvantage of the code entry method is lack of future proofing. That is, new kinds of equipment, that become available after the URC has been manufactured, will not be supported by the URC. This disadvantage is addressed by a URC according to a second exemplary embodiment.

According to the second exemplary embodiment, the URC, which is generally illustrated in FIGS. 1 and 2, is adapted so that the second NV memory 315 contains an (at least partially) empty command protocol library 320, which is at least large enough to contain as many command protocols 323 as the number of components that can be controlled by the URC. For example, if the URC can control four components, there is at least space in the library for four command protocols. This means that the second NV memory of this second embodiment can have a significantly smaller capacity than the second NV memory of the first embodiment, which typically needs to store thousands of command protocols, most of which will never need to be used by any one particular user.

The URC can be programmed according to the foregoing method. A pDVD provided according to this embodiment contains encoded audio content that describes an entire command protocol for each component, which may be selected from the menus. Such a command protocol includes information relating to the carrier frequency used by a component as well as the individual keypad code assignments. Conveniently, the command protocol is encoded into appropriate sounds using an appropriate encoding scheme, for example of the kind already described with reference to the graphs in FIG. 6a or 6b. As illustrated in the timing diagram in FIG. 6c, the command protocol is encoded with a header (HD) to prime the URC to receive the transmission. As already described, the header might be a monotone or sequence of pulses. Then, the carrier frequency (CF) information is transmitted as an integer value. Next, the independent key code assignments (K1-Kn) are transmitted for each key of the URC that may be used to operate the respective component. Finally, a trailing (TR) tone or sequence is transmitted; in order to indicate that all key code assignments have been transferred.

In essence, the second embodiment relays entire command protocols, rather than simply identifying a URC command protocol using an identifier. The URC receives and stores the command protocol in the library in its second NV memory. In addition, the URC writes into its third NV memory a numeric value, which points to the location of the command protocol in the library. In all other respects, the programming process and the URC operate in the same way as in the foregoing embodiment.

The pDVD, which has been described with reference to both aforementioned embodiments, fully complies with the DVD-Video format. The pDVD can, therefore, be authored and produced using standard DVD-Video authoring tools. Most conveniently, however, the pDVD can be authored using the present applicant's DVD-Video development system, DVD-EXTRA STUDIO™, which implements highly efficient authoring procedures, some of which are described in the present applicant's co-pending international patent application WO 03/094519.

According to a third embodiment, a URC is adapted to be a combination of the foregoing two embodiments, by providing a library containing a selection of pre-stored command protocols, which can be programmed according to the first embodiment, and, in addition, space in the second NV memory for adding new command protocols, for example belonging to new equipment that becomes available after the URC has been manufactured. The additional command protocols can be added according to the method of the second embodiment.

As has been described, historically, it has been perceived as being generally onerous to program a URC to control a new piece of equipment. Providing a pDVD, in accord with embodiments of the present invention, can greatly simplify the procedure, insofar as a user is given clear, on-screen instructions and the programming steps are automatic.

The present inventors have appreciated that, in principle, a DVD-Video disc is relatively cheap to author and reproduce, especially if using the applicant's DVD-EXTRA STUDIO system. Accordingly, it is proposed that every new component sold could be supplied with its own URC pDVD; in a similar manner to which computer hardware devices are supplied with appropriate software drivers. Such supply would constitute a small additional overhead for manufacturers, in comparison with the cost of the component. In addition, provision of such a pDVD would be extremely convenient for users, who would typically use the pDVD to program their existing URC (which, of course, would need to comply with embodiments of the present invention) as a small additional step in the normal equipment set-up and commissioning procedure. The present inventors can imagine each manufacturer providing with each new item of equipment a pDVD, which contains all up-to-date URC command protocols for all equipment manufactured by that manufacturer.

Alternatively, or in addition, a generic pDVD, containing programming information for all (or a majority of common) known components, could be regularly updated with new component releases, produced and distributed, thereby providing future-proofing for any URC which operates according to embodiments of the present invention. A pDVD could be supplied for free with each new URC sold and, in principle, the pDVD could be up-to-date even if the URC had been manufactured months or years earlier. In principle, the information stored on a pDVD could be made available on-line, via the Internet, and could be downloaded onto a personal computer and written to a DVD-Video disc for use as described.

Thus far, herein, the exemplary embodiments have dealt with improvements to the ways in which a URC might be programmed to operate various kinds of equipment. However, the principles applied in those embodiments may be extended to areas that have, hitherto, not been addressed in the prior art or, at the very least, have not been practical using known art URC and programming methods.

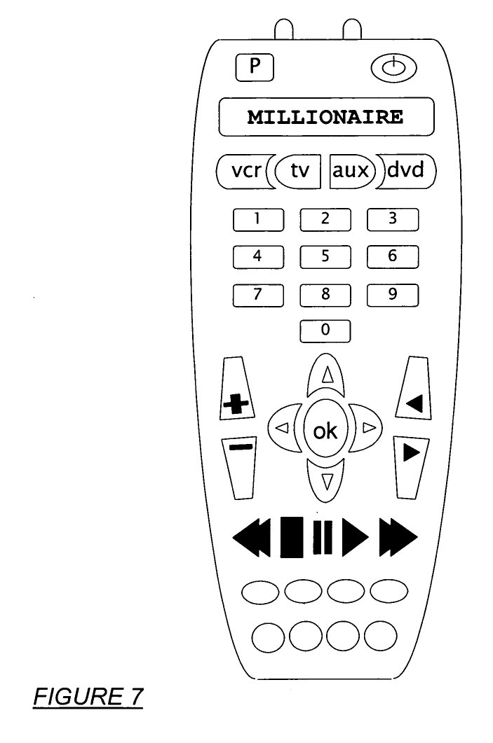

The present inventors have appreciated that the foregoing principles can be applied more broadly than before in order to extend the functionality of a URC for use with a specific DVD-Video title, for example containing interactive content. Such an application has not hitherto been practical using any known prior art URC. The extended functionality could be programmed into unassigned keys 710, for example on a URC 700 as illustrated in FIG. 7, in order to provide custom control of the DVD player for that particular title. In some cases, the extended functionality could instead, or in addition, be programmed into unused (or lesser used) keys, for example numbers 1-9in the numeric keypad.

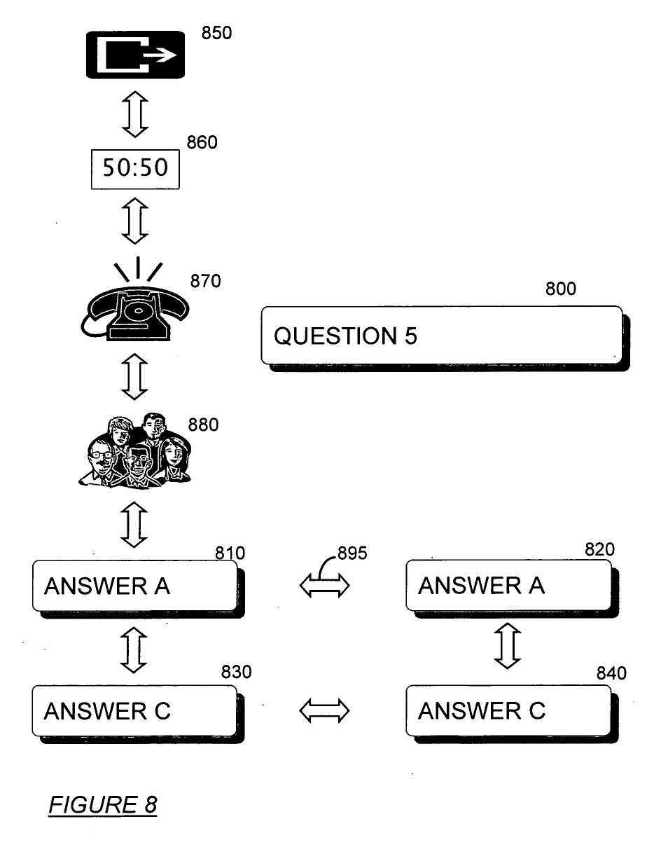

Consider a game produced on a DVD-Video disc, for example the well-known “Who Wants To Be A Millionaire” DVD-based quiz game (DVD catalogue number 9208894, distributed by Universal and published by ©2003 ZOO Digital Publishing), which is based on the original television quiz game show bearing the same name. In this game, a user (or player) advances, and ultimately wins, by selecting the correct answers to fifteen consecutive questions. As illustrated in the diagram in FIG. 8, each question 800 displayed on screen as a menu comprising four possible answers: Answer A 810, Answer B 820, Answer C 830 and Answer D 840. A player navigates to their selected answer on the screen by using the up, down, left and right navigation (or arrow) keys 705, which are provided on all standard DVD player remote controllers, as well as on the present URC 700, and selects the answer by pressing the “OK” key 707. The player is also provided with four additional options: “Walk Away” 850, “50:50” 860, “Phone a Friend” 870 and “Ask the Audience” 880. The “Walk Away” option ends the game; the “50:50” option causes the game to identify two incorrect answers, thereby reducing the chance of ‘guessing’ a wrong answer; and the “Phone a Friend” and “Ask the Audience” options purport to assist in answering a question by simulating a response from a friend or a quiz show audience. Overall, therefore, for each question, the player is provided with eight possible responses (810-890), and the means of navigating through the responses on screen is by using the arrow keys on a DVD player remote controller.

According to a further embodiment of the present invention, it is proposed that an improved player experience for the “Who Wants To Be A Millionaire” DVD game (and, indeed, any other interactive DVD title) can be provided by programming unassigned keys (or unused or lesser used keys) on a URC to behave as dedicated game options. For example, each of the unassigned keys 710 of a URC, which is illustrated in FIG. 7, can be assigned to one of the eight game options. In effect, the URC is customised for the particular DVD title, rather than just to a particular kind of DVD player, and the player no longer has a need to ‘navigate’ through the menu answer options using the arrow keys 705. This provides the player with a gaming experience that is even closer to the real television game show “Who Wants to be a Millionaire”.

According to this embodiment, such customisation requires that each unassigned key needs to be configured to produce a sequence of several control code signals in response to a single key press. The facility to program a key in this manner is already known in the URC art in association with programming URC ‘macros’, which are commonplace on many current URC models. One way of programming macros is described in more detail in U.S. Pat. No. 7,587,067. Advantageously, when only one or a few keys need to be programmed (or reprogrammed) it is not necessary to specify a signalling format during programming (or reprogramming), since the new control codes will be turned into signals using an existing signalling format.

The diagram in FIG. 8 also contains arrows 895 superimposed between the player option areas. These arrows are not displayed by during game play and are included merely to assist with the present explanation. The arrows signify the possible navigation routes that are normally available between the options by pressing the arrow keys. For example, from the “50:50” option, four down arrow key presses are required to navigate on screen to the Answer C option (via “Phone a Friend”, “Ask the Audience” and Answer A); from the Answer D option, a sequence of one up arrow, one left arrow and four more up arrow key presses are required to navigate to the “Walk Away” option (via Answer C, Answer A, “Ask the Audience”, “Phone a Friend” and “50:50”).

In order to customise a URC for use with the “Who Wants To Be A Millionaire” DVD game, the following control sequences (or macros) may be programmed into the unassigned keys:

| Unassigned | | |
|---|---|---|
| Key | Option | Equivalent arrow key presses |
| 1 | Walk away | left, up, up, up, up, up, ok |
| 2 | 50:50 | left, up, up, up, up, up, down, |
| | | ok |
| 3 | Phone a | left, up, up, up, up, up, down, |
| | Friend | down, ok |
| 4 | Ask the | left, down, down, down, down, |
| | Audience | down, up, up, ok |
| 5 | Answer A | left, down, down, down, down, |
| | | down, up, ok |
| 6 | Answer B | left, down, down, down, down, |
| | | down, up, right, ok |
| 7 | Answer C | left, down, down, down, down, |
| | | down, ok |
| 8 | Answer D | down, down, down, down, down, |
| | | right, ok |

Each ‘Equivalent arrow key presses’ control sequence is the maximum set necessary to navigate on screen from any currently highlighted option to a desired option. For example, navigating from Answer D to “Walk Away” requires the entire “Walk Away” sequence of “left, up, up, up, up, up”. However, it will be appreciated that navigating from the “50:50” option to the “Walk Away” option, in principle, only requires the first “up” part of the “Walk Away” sequence. The unused parts of the “Walk Away” sequence, that is “left, . . . , up, up, up, up”, even though executed when Key 1 is pressed, have no effect on the navigation, since, according to the arrows in FIG. 8, once the navigation reaches the “Walk Away” option, additional “left” or “up” commands are not available and, hence, have no effect.

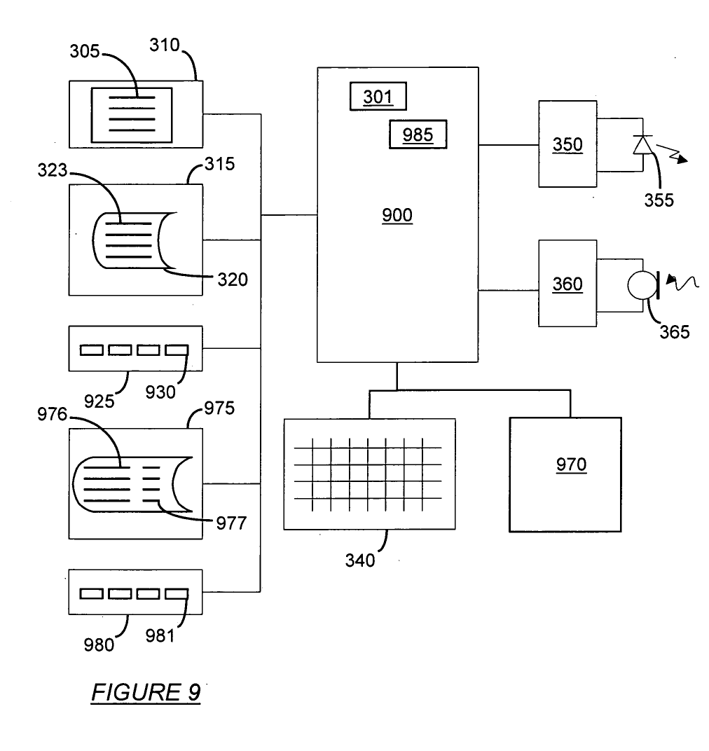

The URC in FIG. 7 is similar to the one illustrated in FIG. 2 apart from the addition of a screen 715, for example an LCD screen, the unassigned keys 710 and a “Title” key 720. The functional arrangement of the URC is illustrated in the diagram in FIG. 9. The functional arrangement is similar to the arrangement illustrated in FIG. 3, apart from the addition of a display driver 970, for controlling the screen, fourth 975 and fifth 980 NV memories and a second microcontroller register 985. The parts of the functional arrangement shown in FIG. 9 that are common with those in FIG. 3 will not be described again for the sake of brevity herein.

Plural command protocols 976 for the unassigned (or re-assigned) keys 710 are stored in the fourth NV memory 975, along with an ASCII string 977, for example “Millionaire”, which describes the DVD title associated with the respective command protocol. The fifth NV memory 980 is similar to the third NV memory 925, insofar as it stores a numeric code 981, which identifies the start point in the fourth NV memory 975 of a respective command protocol 976. The act of pressing the Title key 720 causes the microcontroller 900 to cycle through the numeric values 981 in the fifth NV memory 980 and load each in turn into the second register 985. The microcontroller 900 is arranged to read the second register 985 automatically on each press of the Title key 720, access the control protocol 976 in the fourth NV memory 975 according to the numeric value in the register 985, read the ASCII string 977 associated with that command protocol 976 and cause the display driver 970 to display the ASCII string 977. The URC 700 according to this embodiment of the invention can, thus, store plural command protocols 976 for the unassigned keys 710, and a user can cycle through which protocol to apply simply by pressing the Title key 720. The user knows from the displayed ASCII code which command protocol is applied at any particular time.

The control codes assigned to the unassigned keys 710 are slightly different from those assigned to normal keys. In particular, the unassigned keys 710, like known macro keys, can have assigned to them plural control codes, whereas the normal keys are each typically only associated with one control code.

A URC according to this embodiment can store plural command protocols 976 for the unassigned keys 710, where each protocol is associated with one or more DVD titles. For example, one command protocol would cause the unassigned keys to operate according to the ‘Equivalent arrow key presses’ described above in relation to the “Who Wants to be a Millionaire” DVD game. Other command protocols would be used with other DVD titles.

The command protocols for the unassigned function keys are programmed using a pDVD and a method, for example, as described above. Alternatively, known DVD titles typically have a number of menus, for example for “Set-Up”, “Chapter Selection” and “Special Features” and, in principle, according to embodiments of the present invention, it is proposed that future DVD titles will be authored to include an additional “URC Programming” menu, which, when selected, initiates the kind of URC programming procedure that is described above. This would enable a user to program a URC, for example, so that it acquires the extended functionality described in relation the “Who Wants To Be A Millionaire” DVD game. This would not incur any significant overhead in the DVD authoring process but would significantly enhance the user experience of the DVD. As described, since the URC can store plural command protocols for unassigned (or re-assigned) keys, the user need only program the URC once for each new title (subject, of course, to a maximum number of titles supported by the URC). In addition, keypad overlays could be supplied with each DVD title. A keypad overlay might comprise a plastic strip including holes for the keys to protrude through and respective key identification labels, colour codes, or the like, which enable the user to more readily identify the particular function of each unassigned key for a selected DVD title. A keypad comprising a touch display may generate specific icons to represent the extended functions.

Alternative embodiments of the present invention provide a new kind of URC, which is dedicated to interacting with DVD titles, rather than controlling the normal function of the DVD player. The URC may include an appropriate layout of keys, which are ergonomically designed to be more usable during game play. For example, the URC might include large keys, that can be used in games requiring fast responses (for example to ‘quick-fire’ questions), where smaller keys of a traditional keypad might be too small for an optimum game play experience.

The embodiments of the present invention described so far include a URC, which is programmed using audio content playback. Correspondingly, the URC includes a microphone for receiving the varying sounds of the audio content. In alternative embodiments, the present inventors anticipate that a URC may be programmed by video content, for example in the form of varying light levels generated by playing back appropriately encoded video content. In this event, a light detector (responsive to variations in visible light produced by a visual display) and appropriate circuitry would replace the microphone and receiver circuitry of the embodiments described hereinbefore.

For example, the content may comprise an encoded sequence of consecutive light and dark screens. The variation in screen brightness may fill the entire screen or may fill only a relatively small region of a screen. It is suspected that rapidly varying screen light levels may induce undesirable reactions in people who suffer with epilepsy. As such, reproducing the code in a small region of the screen may be preferable and, in addition in this case, user messages may be played back in other regions of the screen.

The encoding may instead be achieved using different colours, for example using consecutive red and green colours, where the light detector is tuned to differentiate between the colours. Many other light encoding schemes are anticipated and would become apparent to the skilled person on reading this description. For example, a barcode or the like may be presented on a screen as a still image and the URC may be ‘scanned’ manually across the barcode. Portable barcode readers are well known and a URC incorporating similar technology would be easy for the skilled person to produce.

Although the exemplary embodiments of the present invention have concentrated in programming a URC using DVD playback of a pDVD, other embodiments of the invention are not limited in this way. For example, it is anticipated that other forms of playback equipment could be used to program a URC. In a very simple case, when recorded media is provided for programming a URC to operate with only one (or a few pre-defined) devices, audio programming information could be provided on CD, minidisk or even on magnetic tape. Clearly, such types of media playback would not be as convenient for providing interactive content, for example equipment selection menus, but there is no reason why simple URC programming could not be achieved using such sequential media and playback equipment. In addition, simple or even interactive content could be provided for playback by other kinds of equipment, such as hard disc or solid-state media players. For example, playback could be via an MP3 player or a palm or handheld device such as a Palm Pilot™ or an Apple™ iPod™. Similarly, the programming content could be loaded onto a hard disc video recorder and accessed in a similar manner to the DVD player. The content could be copied from a pDVD, downloaded from the Internet or even from a satellite or terrestrial television channel or Teletext sub-channel.

As the reader will appreciate, there are many different ways—far more than can be described herein—in which embodiments of the present invention may be implemented. Accordingly, only the claims appended hereto, as influenced by any broadening purposive construction or equivalence doctrine or theory, should be used to limit the scope of the invention.

The above embodiments are to be understood as illustrative examples of the invention. Further embodiments of the invention are envisaged. For example, rather than being sensitive to playback of audio or visual content through a television or the like, the playback signals might be transmitted to the remote controller electrically via a cable or lead, for example plugged into a headphone socket or the like of standard audio playback equipment. An advantage of such an arrangement would be that the sound would not need to be rendered through a loudspeaker, and hence the operation would be silent, which might be less intrusive to the operator. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A remote controller, comprising a receiver for receiving programming information for programming the remote controller and a transmitter for transmitting remote control signals for controlling remote equipment, wherein the receiver is sensitive to the playback of audio or video content to receive therefrom information for programming the remote controller.

2. A controller according to claim 1, further comprising a processor, an operator interface and memory means.

3. A controller according to claim 2, which is arranged to store received information in the memory means.

4. A controller according to claim 3, which is arranged to store in the memory means received information which identifies a command protocol for controlling remote equipment.

5. A controller according to claim 3, which is arranged to store in the memory means received command protocol information for controlling remote equipment.

6. A controller according to claim 5, which is arranged, in response to respective user interaction with the operator interface, to transmit at least one control code, which is defined by the command protocol, in order to control the remote equipment.

7. A controller according to claim 1, wherein the receiver comprises a microphone.

8. A controller according to claim 7, wherein the microphone is sensitive to sound in the audible frequency range.

9. A controller according to claim 8, wherein the microphone is sensitive to sound generated by one or more loud speakers.

10. A controller according to claim 1, wherein the receiver comprises a light detector.

11. A controller according to claim 10, wherein the light detector is sensitive to light in the visible spectrum.

12. A controller according to claim 10, wherein the light detector is sensitive playback of video content through a visual display unit.

13. A controller according to claim 1, which is arranged to receive information for programming the remote controller via playback of encoded audio content.

14. A controller according to claim 13, which is arranged to receive information for programming the remote controller via playback of encoded audio content comprising a pre-defined sequence of audio pulses, frequencies, levels, tones, cadences, or any combination thereof.

15. A controller according to claim 10, which is arranged to receive information for programming the remote controller via playback of encoded video content.

16. A controller according to claim 15, which is arranged to receive information for programming the remote controller via playback of encoded video content, comprising a pre-defined sequence of light pulses, intensities, shades, hues, images or any combination thereof.

17. A controller according to claim 15, which is arranged to receive information for programming the remote controller via one or more barcode images.

18. A method of programming a remote controller, comprising the steps of playing back audio or video content containing programming information for programming a remote controller and arranging a remote controller to receive said information, said remote controller being sensitive to, and programmable by, said information.

19. A method according to claim 18, wherein the programming information comprises an identifier for identifying a command protocol for controlling remote equipment.

20. A method according to claim 18, wherein the programming information comprises a command protocol for controlling remote equipment.

21. A method according to claim 20, comprising the step of using the command protocol to program the remote controller.

22. A method according to claim 21, including the step of using the programmed remote controller to control remote equipment.

23. A method according to claim 18, comprising the step of playing back the audio or video content using AV apparatus, which reads the content from a data carrier.

24. A method according to claim 23, wherein the data carrier is removable from the AV apparatus.

25. A method according to claim 24, wherein the data carrier is an optical disc.

26. A method according to claim 25, wherein the optical disc substantially conforms to the DVD-Video format and the AV apparatus is a DVD player.

27. A method according to claim 18, comprising the step of generating one or more user menus for providing a list of equipment that can be controlled by the remote controller.

28. A method according to claim 27, comprising, on the basis of a menu selection, the step of replaying audio or video content containing programming information for programming the remote controller to be able to control the selected equipment.

29. A method according to claim 18, comprising the step of playing audio content in which is encoded information for programming the remote controller.

30. A method according to claim 29, wherein the audio content comprises a pre-defined sequence of audio pulses, frequencies, levels, tones, cadences, or any combination thereof.

31. A method according to claim 18, comprising the step of playing video content in which is encoded information for programming the remote controller.

32. A method according to claim 31, wherein the video content comprises a pre-defined sequence of light pulses, intensities, shades, hues, images or any combination thereof.

33. A method according to claim 31, wherein the video content is encoded as one or more barcode images.

34. A method of authoring a removable data carrier, such as a DVD, including the step of storing thereon audio or video content containing information for programming the remote controller of claim 1.

35. A method according to claim 34, including the step of generating the audio or video content.

36. A removable data carrier, which contains audio and/or video content for programming a programmable remote controller as claimed in claim 1.

37. A removable data carrier according to claim 36, comprising an optical disc.

38. A removable data carrier according to claim 37, comprising a DVD-Video disc.

39. A removable data carrier as claimed in claim 36, which contains a film or game.

40. A removable data carrier as claimed in claim 39, wherein the audio or video content comprises information for programming a programmable remote controller to interact with specific functions or aspects of the film or game.

41. A remote controller device comprising means for receiving programming information associated with remote controlled equipment from an audiovisual playback source, means for programming the operation of the remote control device using the programming information, user input means for facilitating user operation of the remote control device, and means for generating control signals, on the basis of the programming information and user input, for controlling said remotely controlled equipment.
